(19) United States
(12) Patent Application Publication
(10) Pub. No.: US 2017/0307211 A1
(43) Pub. Date: Oct. 26, 2017

(54) METHOD AND DEVICE FOR THERMAL MATERIAL TREATMENT IN A PULSATION REACTOR

(71) Applicant: Horst Büchner, Meiningen (DE)

(72) Inventor: Horst Büchner, Meiningen (DE)

(21) Appl. No.: 15/492,292

(22) Filed: Apr. 20, 2017

(30) Foreign Application Priority Data
Apr. 22, 2016 (DE) 10 2016 004 977.4

(51) Int. Cl. F23C 15/00; F27B 1/26

(52) U.S. Cl. CPC F23C 15/00; F27B 1/26

(57) ABSTRACT

The invention relates to a device and a method for thermal treatment of a raw material in an oscillating hot gas flow of a pulsation reactor, comprising a burner, which is supplied with a mass flow, via at least one pipeline, for forming at least one flame, which produces the oscillating hot gas flow, wherein the flame is arranged in a combustion chamber, and wherein a reaction chamber follows the combustion chamber downstream of the combustion chamber. In order to be independent of the dimension of the device, it is proposed to provide the mass flow that is supplied to the flame with an externally impressed pulsation. The combustion chamber and/or the reaction chamber can then be varied in geometry to avoid resonances.

### CROSS-REFERENCE TO RELATED APPLICATION

This application claims priority to German Application No. DE 10 2016 004 977.4, filed Apr. 22, 2016 the entire disclosure of which is incorporated herein by reference.

### FIELD

The invention relates to a device as well as a method for the thermal treatment of a raw material in an oscillating hot gas flow of a pulsation reactor (i.e., pulse combustor), comprising a burner, which is supplied with at least one flow of fuel gas and air to form at least one flame, which contains the hot gas flow, wherein the flame is arranged in a combustion chamber and wherein a reaction chamber adjoins the combustion chamber downstream.

### BACKGROUND INFORMATION

For the purpose of the present invention, a thermal treatment is understood to be a thermal material treatment as well as a thermal material synthesis, which may comprise, for example, drying, calcinations, a crystal conversion, etc. For the purpose of the present invention, the term raw material is used both for a uniform raw material and for a raw material mixture. The raw material or else the raw material mixture can be present in solid, liquid, gaseous or vapour form.

The raw material is introduced into the pulsating hot gas flow generated by the flame and, after its treatment as a product, is again separated from it, for example in a cyclone, a hot gas filter or the like.

In principle, it is to be assumed that by far the maximum number of all technical or industrial combustion systems and combustion systems are designed and operated in such a way that the combustion process in the flame runs on an average in a steady state manner with the exception of small turbulent fluctuations, whose order of magnitude is at least smaller than the time averaged values of the combustion process, such as, for example, the mean temperature of the flame or the exhaust gas flow, the average static pressure in the combustion chamber, etc. This means that the conversion of the fuel used takes place continuously over time and, as a result, even the heat release from the combustion process and the mass flow of nascent exhaust gas (combustion products) for a fixed burner setting have temporally constant values.

In contrast to this, phenomena or “abnormalities” occur, which are referred to in the literature as combustion chamber oscillations, self-excited combustion instabilities or thermo-acoustic oscillations. These are characterized by the fact that the initially stationary (i.e., temporally constant) combustion process, wherein the stability limit suddenly auto-changes into a self-excited, time-periodic, oscillating combustion process, the time function of which can be described as a good approximation as a sinusoidal.

In addition to this change, the heat release rate(s) of the flame(s) and thus the thermal combustion performance of the combustion unit, as well as the exhaust gas flow into and from the combustion chamber, and the static pressure in the combustion chamber itself are periodically transient, i.e., swinging /1, 2/.

The occurrence of these combustion instabilities often results in a change in the pollutant emission behavior, which is different from the stationary operation of the combustion and causes a markedly increased mechanical and/or thermal load on the system structure (e.g., combustion chamber walls, combustion chamber lining, etc.), which can lead to the destruction of the furnace or individual components. It is, therefore, easy to understand that the undesired occurrence of the phenomena, as described above, in combustion systems designed for a steady state combustion process, in which the static pressure in the combustion chamber or in upstream or downstream system components (constant-pressure combustion) must also be avoided.

The situation is quite different in the case of a small number of very special combustion systems, in which the above-described phenomenon of self-excited, periodic combustion instabilities is intended and is used to perform a periodic combustion process with a periodic heat release rate of the flame and periodic oscillating exhaust gas flow (pulsating hot gas flow) in the combustion chamber and in downstream system components (e.g., heat exchangers, chemical reactors, etc.).

For more than forty years, there has been reports in relevant patent literature of chemical reactors, in which a thermal treatment of an abandoned raw material (educt) or a thermally controlled material synthesis from one or more raw materials is carried out and are typically designated as pulsation reactors, pulse dryer or pulse combustor /3, 4, 5, 6/.

It is common to all these reactors that the thermal material treatment is carried out in a pulsating, oscillating hot gas flow, i.e., periodically—transiently, whereby both the heat required for the thermal material treatment/material synthesis as well as the mechanical oscillation energy of the pulsing hot gas flow from a non-stationary, oscillating combustion process of a fuel, such as, in particular, natural gas, hydrogen, liquid fuels, etc.

The advantage of these systems compared to conventional, stationary combustion systems is the periodically transient oscillating and turbulent exhaust gas flow in the combustion chamber or in downstream components (for example, heat exchangers, reaction chambers, resonance tube, etc.).

Not only toward solid walls (combustion chamber wall, wall of a heat exchanger, steam generator, etc.) as well as toward the material, which is introduced for treatment in hot gas flow with defined process temperature, the heat transfer from the hot gas to walls or material increases significantly by 2 to 5-times toward an average stationary, turbulent flow of comparable average flow velocity and the same temperature. For this reason, the material to be treated undergoes high heating gradients (“thermal shock treatment” /6/) in pulsating hot gas flows.

On the basis of the analogy between convective heat transport and mass transfer, the above statement also applies to the mass transfer. In the case of the periodic-transient, oscillating flow, the transfer rate of gaseous or vaporous substances from hot gas to the material to be treated or from the material to the hot gas flow rises by similar values because of the almost complete absence of boundary layers, which arise in the case of stationary flows, and constitute the diffusion and/or transfer resistances.

The reactors /6, 7, 8, 9/ described in the prior art typically consist of a combustion chamber, in which the reaction conversion of the fuel used is liberated in a flame or flame-free with the liberation of heat chemically bound therein as well as of a reaction chamber connected to the flow direction, which is frequently referred to as a “resonance tube”, into which the raw material is added and in which thermal material treatment takes place. In a few, a particular embodiment, the raw material is already put into the combustion chamber.

A considerable disadvantage of the pulsation reactors for thermal material treatment/thermal material synthesis according to the prior art occurs in the context of a new material development.

In order to ensure that the product properties achieved in the course of such a novel material development by thermal material treatment in a pulsation reactor are qualitatively and quantitatively contained during transfer from the development stage to the production stage, i.e., in particular in the case of a mass production of a product in a customary production unit, it is imperative, as per the state of art, to carry out the material development with the same reactor size, with which mass production of the finished product is to be carried out later.

A “Upscale” normally possible in industrial installations by a factor of 1:10 to 1:50 in the case of a transition from a sample production during development with a laboratory reactor to a mass production in a production (large) reactor with the safe retention of the derived development sequences (material properties of the new product) is currently not technically feasible with the described pulsation reactors.

In the following, the physical cause is explained for this undesirable absence of the scalability of pulsation reactors, which is undesirable under various aspects, which have an impact on the undesirably changing material properties in the production of products in pulsation reactors of different sizes (different plant capacities) and to a comparable degree, on the various designs of reactors:

If one starts from the desirable situation, there would be a small version of a oscillation-induction reactor for thermal material treatment, that is, a “laboratory reactor” which could be used in material development in the context of a sample production, for example, with a throughput rate of 10 kg of product per hour, and on the other hand, there would be a corresponding large-scale version of such a reactor for mass production of the same product, for example, with a throughput rate of 150 kg per hour.

Even on the assumption that both the temperature of the hot gas into which the raw material is fed into the two reactors, i.e., the material treatment temperature, as well as the residence time, during which the raw material is exposed to hot gas flow, i.e., the material treatment duration, is identical to the two reactors, the thermal material treatments in the two reactors differ significantly in respect of the oscillation or pulsation frequencies and amplitudes occurring in the two reactors. In this case, these influence the respective heat and mass transfer rates from the oscillating hot gas flows to the particles to be treated, and thus the material properties that are found in the resulting products.

The above differences in respective oscillating frequencies and amplitudes are due to the circumstance that, in the case of the smaller embodiment, self-excited combustion instability typically occurs at higher oscillation frequencies than in the case of a constructional, i.e., geometrically much larger production unit.

A similar phenomenon occurs in organ pipes, in which the length of the organ pipes is determined taking into account the excitable, developing basic frequency: A great length correlates with a low frequency of the producible tune and a small length correlates with a high frequency of the producible tune. The organ pipes are open or covered, depending on whether they are half or quarter wave resonators.

Even the amplitudes of the oscillating of the hot gas flows in the two reactors change, in particular, because of the oscillation damping of the oscillation overall system that is strongly non-linearly dependent on the reactor geometry and the oscillation frequency.

At present, the said problem of the lack of scalability is circumvented in a time-consuming and cost-intensive manner by carrying out tests for material development as well as a subsequently recorded production for achieving identical material properties of the produced products always with reactors of the same size and design.

Thus, due to these hitherto existing limitations with regard to the retention of material properties with size and throughput scales of pulsation reactors for thermal material treatment according to the prior art, the development costs of new products based on this technology are strongly increased compared to other thermal methods, because during development or optimization tests as well as in the production of sample quantities for the physical-chemical analysis of achieved material properties in new product developments, disproportionately high raw material quantities must be used and on the other, unnecessarily high energy and personnel costs would arise for tests on full-scale execution of these reactants.

### SUMMARY

It is, therefore, an object of the present invention to further develop a device in the lines as described so far that it is substantially more independent of its geometric dimensions so as to become more free in the research and testing of corresponding methods for thermal material treatment or thermal material synthesis as well as corresponding procedures.

This object is achieved with respect to the said device in that an externally drivable pulsation device for at least a part of the mass flow directed to the burner is arranged upstream in the pipeline leading to the flame.

The device and the method according to the invention, which have an externally driven and adjustable pulsation amplitude and frequency for the mass flow, have the advantage that the fuel/air mixture flowing to the burner in the case of a premixed combustion or the combustion-air mass flow can be modulated periodically in a controlled manner in the case of a diffusion combustion, and an operator will thus be able to adjust the frequency and amplitude of the said mass flow fluctuation on the one hand independent of each other and on the other, independent of all other process variables.

Thanks to the drivable pulsation device, the flame, which generates the hot gas flow necessary for thermal treatment, is positively excited by the periodically oscillating supply of either fuel/air mixture or combustion air. It thus oscillates precisely with frequency and amplitude, which are set at the pulsation device.

The invention is based on the realization that, as can be seen from the use of the “resonance tube”, there is an essential and also persistent error with regard to the phenomenon, which is responsible for the generation of the oscillating hot gas flow:

The above-described phenomenon of self-excited combustion instabilities occurring in prior art relates to a system instability, in which, upon reaching a plant-specific stability limit from a stationary, oscillation-free operating state with a stationary combustion process, the system changes in a periodically transient, oscillating operating state with periodic-non-stationary combustion process, without an external excitation of the system being present.

Actually, the term “resonance” refers to a phenomenon, which is physically completely different, namely that of an externally or positively excited oscillation. A system capable of oscillation is excited to resonate by an external periodic excitation (e.g., periodic force effect due to periodic imbalance, etc.) to “resonation”.

In the case of the pulsation reactors as described in the prior art, there is in fact no resonance phenomenon in the actual sense, since there is no periodic excitation source, which displaces or excites the gas column, e.g. in the resonance tube in periodic oscillations to resonance.

Instead, as already stated, the system relates to a system stability, which involves the entire reactor, and for its oscillation frequency, the coupled oscillating behaviour of all system components (burner—combustion chamber—reaction chamber (“resonance tube”) separation devices (filter, cyclone)—etc.) is responsible.

The oscillation frequencies, which are established in the reactors according to the prior art with self-excited combustion instability, therefore do not correspond to the resonance frequency of a component, such as, for example, the “resonance tube”, but are determined by the entire system—and therefore, of course, also by the respective design variable of the reactor—which have very different plant-specific values /10/.

In the subject matter of the invention, the time-modulated supply to the flame with fuel/air mixture or with combustion air simultaneously changes the heat release of the oscillating flame, which is likewise periodic and, at the same time, is constant with the forced excitation of the flame. A pulsing hot-gas mass flow is thus obtained, in which one is able to adjust the frequency and the amplitude independent of each other without the geometrical dimensions of the reactor being of significance for this purpose. It is important in this respect that the oscillations are self-excitation in the known reactors, while they are forced-excited in the case of the invention.

A particularly effective adjustability of frequency and/or amplitude of the flame can be brought about in particular by a corresponding influence, in particular, of primary air, which is fed to the burner for the flame, which produces the hot gas flow, preferably the entire fuel/air mixture. An active pulsation of secondary air flows, such as were previously used, for example, in solid fuel combustion systems, do not lead to the desired immediate changes in amplitudes and frequencies of the hot gas flow in a material treatment reactor, which is the main focus here.

It is also significant that it has surprisingly been found that the properties of products of a thermal material treatment or synthesis have proven to be independent of whether they have been produced by means of a device according to the invention with a forced excitation of oscillating stream of hot gases or by means of a pulsating, periodic but self-excited hot gas flow.

In a particularly preferred embodiment of the invention, the combustion chamber is additionally provided with at least one element for changing its geometry. The reaction chamber can also be provided with a corresponding element for changing its geometry, wherein corresponding elements in the reaction chamber can be provided both alternatively and cumulatively with those in the combustion chamber. Further, it should be pointed out here for the sake of good order that the combustion chamber and the reaction chamber can be separated from each other as well as merged directly into each other.

The above-mentioned elements for altering the geometry can be relevant here since the resonance frequencies of the combustion chamber and/or the reaction chamber can be met with the forcibly excited frequency of the flame. This can lead to an excitation of the hot gas oscillation present in them. In such a resonance case, a strong resonance-induced increase takes place in the nascent oscillation amplitudes. In order to avoid this for all frequencies, which can be generated in principle by the described pulsation device, the combustion chamber and/or the reaction chamber must be damped so strongly that there is a supercritical damping and therefore, no resonance amplification of oscillation amplitude can occur in the case of excitation with resonant frequency. In principle, such an embodiment is also referred to as a “passive combustion chamber”.

The alternatives are the above-mentioned modification elements for the geometry of the combustion chamber and/or of the reaction space, since with the help of the latter, the frequency-dependent position of resonance increase(s) can be variably adjusted. The frequency of the resonance region of the combustion chamber and/or of the reaction chamber can thus be shifted or so adjusted that the resonance excitation is not allowed, and thus impermissible amplitude peaks can no longer occur for the excitation frequency of the flame, which has just been set by the pulsation device.

According to the invention, it is now possible to build a pulsating hot gas reactor for the thermal material treatment even in a small version or as a laboratory reactor. In this hot gas reactor, a flame oscillation with adjustable amplitude and adjustable frequency can be positively excited via the externally driven pulsation device. Both can be adjusted independent of each other.

Thus, with a device according to the invention, it is possible to simulate the conditions of a thermal material treatment with a forced-excited flame/hot-gas oscillation, which are identical to the corresponding oscillation, as they occur in a pulsation reactor, which is driven by self-excited combustion instabilities. This applies to all frequencies and amplitudes occurring as a function of the size and design.

It should again be pointed out that, surprisingly, the material properties of a product produced in such a small or laboratory reactor correspond to those, which are subsequently achieved in a mass production with a production unit having considerably larger dimensions.

The inventor has thus found a way of overcoming the dependency, which has hitherto existed in the case of produced material properties of the dimensions of a pulsation reactor. While the frequency and amplitude of the oscillating hot gas flow due to self-excited combustion instabilities are self-adjusting as a function of the size and design of the individual pulsation reactor, in the context of material development experiments or small-scale production, specific treatment conditions in a laboratory reactor as described above can now be precisely configured and thus the self-excited oscillation behaviour of a large-scale plant in a laboratory system with forced excitation can be simulated.

The invention also provides the possibility that if, from a pulsation reactor, in which the production of a new product is to be carried out, a self-generating and adjusting frequency and amplitude are known based on a self-excited combustion oscillation, then material developments, optimization experiments and a sample production can be accurately carried out with these previously known values in a laboratory reactor. It is thus possible to ensure that the development results arising from the material properties of the product can be transferred to the products, which are achieved in mass production in full-scale.

A cylinder/piston unit can, for example, be provided as a pulsation device, which is arranged in the line leading to the burner. The piston is moved back and forth by means of a particularly external drive, so that with it, fuel-air mixture or combustion air is sucked in and expelled again, so that the desired and essentially sinusoidal pulsation occurs in the burner, located downstream the cylinder/piston unit.

In addition to the frequency, at which the piston is moved back and forth, the amplitude can also be adapted, as required, by way of the stroke, which can be adjusted for this purpose by the piston.

In a space that is connected to the pipeline leading to the burner, a comparable embodiment has a membrane, which partly forms the wall of this space and which can be excited externally to oscillation. The volume of the space continually decreases and increases as a result of the oscillating movement of this diaphragm, and as a result of this volume change, the mass flow delivered to the burner via the pipeline can be brought into a substantially sinusoidal pulsation.

A further possibility for generating a pulsating flow to the burner is the use of quick-closing valves upstream of the burner.

In a particularly preferred embodiment, a pulsation device is provided in the pipeline leading to the burner, said pulsation device comprises a cylindrical housing, in the circumferential surface of which a hole with a sinusoidal edge and a rectangular surface are located. Through this opening, the mass flow of fuel gas/air mixture or combustion air flows from the interior of the housing into a connected line which leads to the burner.

The opening with sinusoidal edge is periodically closed by a multi-vane rotary gale valve, which is arranged in the interior of the pulsation device, in particular for mass flow flowing out of the housing. The rotary gale valve is driven by a motor with adjustable speed.

Thanks to this periodical closing of the opening with sinusoidal edge from the housing of the pulsation device, the gas mass flow passing through it (fuel gas/air mixture or only combustion air) is periodically and thus sinusoidally modulated temporally. The frequency of the mass flow modulation is adjusted by the speed of the driving motor and the number of the vanes of the rotary gale valve. This frequency lies typically in a frequency range between 1 Hz and 500 Hz.

By means of an additional blocking of the rectangular opening from the housing of the pulsation device with a static, non-rotating second gale valve, a bypass mass flow, always exiting in the direction of the burner, can be precisely adjusted and thus the pulsation amplitude of the forced mass flow oscillation can be determined.

In the limiting case, when the rectangular opening is completely closed and the rotary gale valve completely closes the opening with a sinusoidal edge, the mass flow emerging from the pulsation device, which flows to the burner, is almost zero.

If the rotary gale valve opens the opening with a sinusoidal edge again, then the mixture or air mass flow flowing out of the pulsation device and flowing into the burner rises steadily until it reaches its maximum, in order to experience a decrease later with increasing closure of the opening with a sinusoidal edge again.

With such a pulsation device, which represents only one exemplary embodiment, the flame is forced via the periodically oscillating supply of fresh fuel/air mixture or combustion air, specifically with exactly the frequency and amplitude, which are set in the pulsation device.

As a result of the time-modulated supply of the flame with fuel/air mixture, the instantaneous heat release of the oscillating flame as well as the instantaneous hot gas mass flow resulting from the combustion process in the flame also changes periodically and uniformly with forced excitation. Thus, in this way, a pulsing hot-gas mass flow is produced with a frequency and amplitude, which can be set independent of one another, in which the desired thermal material treatment of the raw material can be carried out without the dimensions of the reactor assuming significance for this purpose.

### BRIEF DESCRIPTION OF THE DRAWINGS

Further advantages and features of the invention will become apparent from the following description of exemplary embodiments.

FIG. 1 shows a principle diagram of a device for thermal treatment of a raw material in an oscillating hot gas flow;

FIG. 2 shows a device for generating an oscillating mass flow in the external view; and

FIG. 3 shows a device according to FIG. 2 in a sectional view.

### DETAILED DESCRIPTION

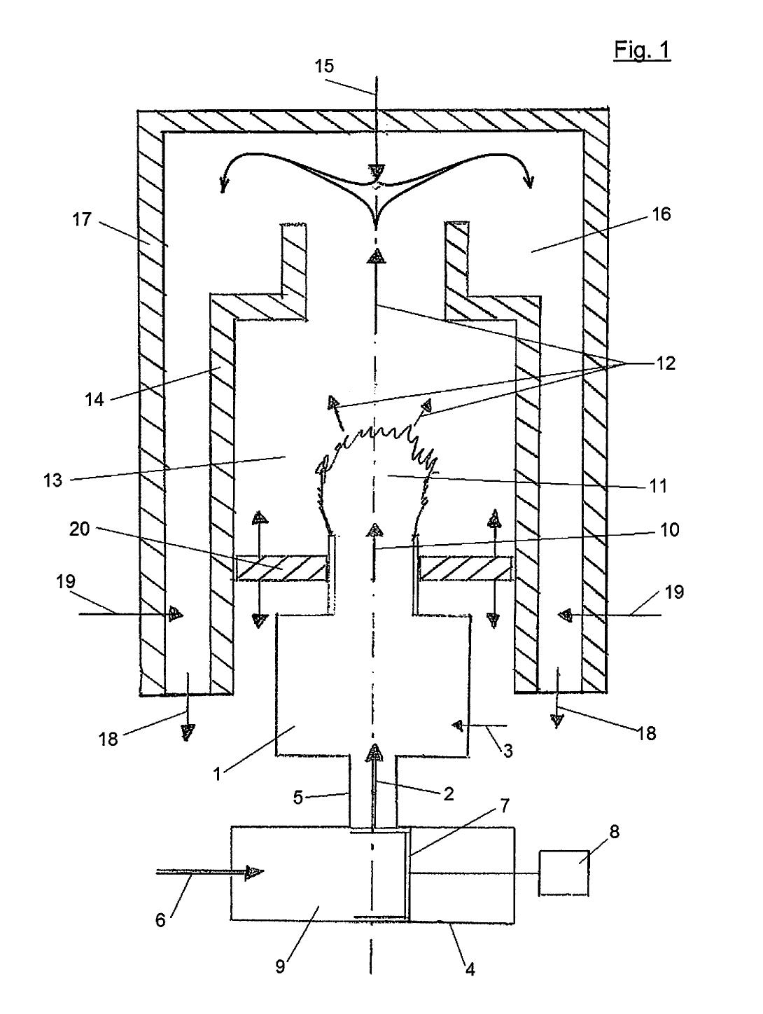

FIG. 1 shows a device for thermal treatment of a raw material in a oscillating stream of hot gas in the sectional view as a schematic representation.

A pulsating mass flow 2 is fed to burner 1. In the case of this mass flow, it relates to either combustion air, when burner 1 is a diffusion type burner or to a fuel/air mixture when burner 1 is a premixed burner, which is preferred. If the pulsating mass flow 2 is exclusively a combustion air for a diffusion burner, then fuel 3 is fed separately to burner 1.

In contrast to a premixed burner, a diffusion burner has the problem that the pulsating combustion air can partially lead to an oxygen deficiency, from which undesirable combustion values, e.g. soot, are generated in hot gas flow to be generated with the burner. Such combustion residues lead to a contamination of the material to be treated or synthesized. Therefore, instead of fuel 3, a further fuel/air mixture can be added here in the case of a premixed burner. The mass flow entering at the outlet of the burner in a flame generated there is then pulsed as a whole, whereby it is composed essentially of a uniformly flowing basic flow and a mass flow excited to pulsation.

The pulsating mass flow 2 originates from a pulsation device 4, which is integrated upstream of burner 1 into the pipeline 5, with which the pulsating mass flow 2 is fed to burner 1.

A continuous mass flow 6, which is converted into the pulsating mass flow 2 via the pulsation device 4, is fed to the pulsation device 4.

The pulsation device 4 can have a piston 7, which is reciprocated by means of a motor 8 so that the pulsation is thereby imposed on the continuous mass flow 6, which transforms it into the pulsating mass flow 2.

Instead of a piston 7, a membrane can also be moved, which forms a wall of the space 9 through which the mass flow flows. The pulsation of the mass flow 2 can also be produced in this way.

At the end of the burner 1, the pulsing fuel/air mixture 10 flows into a flame 11; this accordingly pulsates excitedly and thus generates a pulsating hot gas flow 12. The pulsating flame 11 thereby burns in a combustion chamber 13, which has a possibly double-walled, water-cooled wall 14.

Raw material 15 is added to the pulsating hot-gas flow 12, which leaves the combustion chamber 13, with which the raw material is passed through a reactor chamber 16, which is fluid-dynamically connected to the combustion chamber 13. The reactor space is, as required, provided with a double-walled, air-cooled or water-cooled wall 17.

The raw material 15 fed into the pulsating hot-gas flow 12 is correspondingly treated in the reactor chamber 16, whereby, depending on the composition of the raw material or raw material mixture, a material synthesis can take place here.

At the end of the reactor chamber 16, the finished product is discharged from the reactor chamber 16, whereby it is possible to add cooling air 19 to the hot gas flow, in order to quench the product 10 produced.

The product discharged from the reactor chamber 16 is then separated from the hot gas carrying it via a hot gas filter (not shown) or a cyclone.

It has been found that the dimensions of the device shown here are ultimately irrelevant for the finished product as long as the frequency and the amplitude of the pulsing hot gas flow 12 are fixed. This setting can be brought about via the pulsation device 4, which imposes its frequency and amplitude on the pulsating mass flow 2.

In order to prevent the occurrence of undesired resonances in the combustion chamber 13 and in the reactor chamber 16 downstream the latter, which would lead to an undesirable increase in the amplitudes produced in the present case, the device is provided with a modification element 20 for the geometry of the combustion chamber or the reaction chamber. In the illustrated example, this change element is formed by a displaceable bottom 20 of the combustion chamber 13. With this change element 20, the resonance frequency of the device shown here can be modified in such a way that it can no longer lead to an undesirable resonance-induced amplification of the amplitudes, which are generated by the pulsating flame 11.

It should be pointed out at this point that the combustion chamber as illustrated here and the resonance chamber connected to it are in principle constructed like a Helmholtz resonator, i.e., not like half-wave or quarter-wave resonators similar to organ pipes, as described above. Thus, with conventional dimensions of such a device that can be used as a laboratory reactor, depending on the position of the modification element and the volume resulting there from, e.g., the combustion chamber as a Helmholtz resonator and the set temperature of the hot-gas mass flow, it can have a resonance frequency of about 40 to 160 Hz, which is to be avoided as operating frequency.

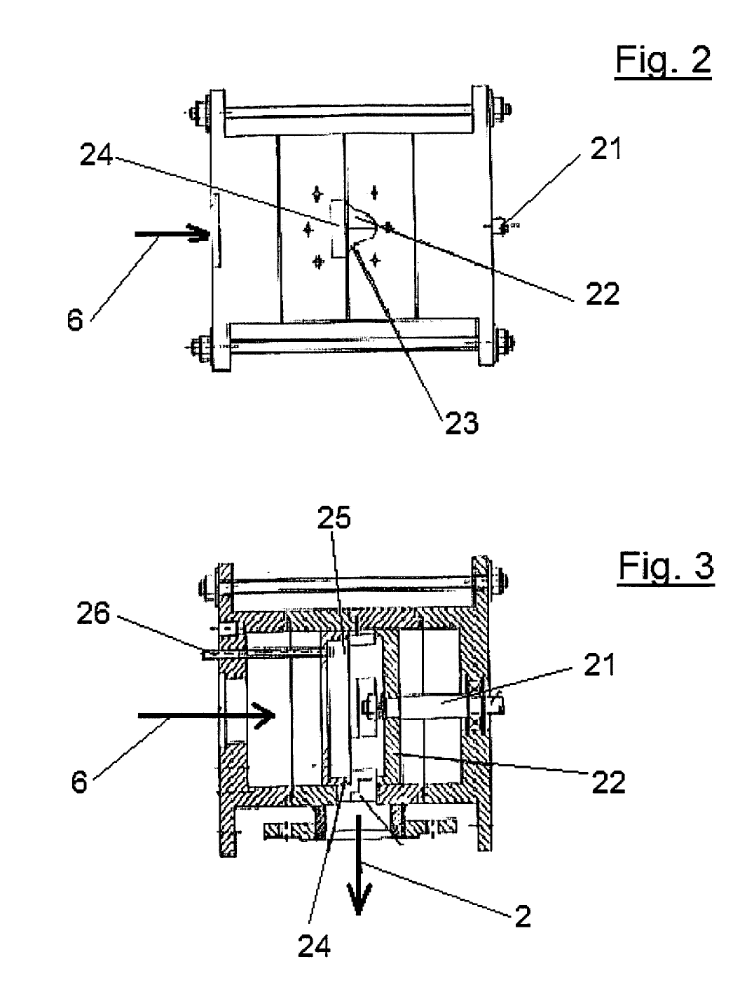

FIGS. 2 and 3 show a suitable pulsation device in more detail: via a motor shaft 21, a multi-vane rotary gale valve 22 can be rotated, which opens and closes an opening 23 with a sinusoidal surface. Through this opening 23, the mass flow 6 flowing continuously into the pulsation device is converted into a pulsating mass flow 2, whereby the pulsation has a substantially sinusoidal course, because the opening 23 has a sinusoidal surface through which the mass flow takes place. The set frequency of the mass flow can then be determined or regulated by the rotational speed generated by the drive shaft 21 on the rotary gale valve 22 and by the number of vanes, which the rotary gale valve 22 has. A frequency between 1 Hz and 500 Hz is customary here.

It is also possible to supplement the opening 23 with a section of rectangular form 24. By means of a second gale valve 25, which can close this rectangular section as required, a uniform basic flow can now be implemented for the mass flow, which causes a bypass flow with respect to the pulsating mass flow.

The second gale valve 25 can be adjusted accordingly via a positioning pin 26.

### REFERENCE LIST

1 burner
2 pulsating mass flow
3 fuel
4 pulsation device
5 pipeline
6 continuous mass flow
7 pistons
8 motor
9 chamber exposed to the mass flow
10 pulsating fuel/air mixture
11 flame
12 pulsating hot gas flow
13 combustion chamber
14 walls
15 raw material
16 reactor space
17 walls
18 product
19 cooling air
20 change element
21 drive shaft
22 rotary gale valve
23 opening
24 rectangular section
25 second gale valve
26 positioning pin

### LITERATURE

/1/ A. A. Putnam and W. R. Dennis: “Organ Pipe Oscillations in Flame-filled tubes”; Proc. Comb. Inst. 4, S. 556 ff., 1952
/2/ H. Büchner: “Experimental and theoretical studies of the mechanisms of self-excited pressure oscillations in technical premixed combustion systems”; Dissertation, University of Karlsruhe, Shaker-Verlag Aachen, 1992
/3/ DD 114 454 B1
/4/ DD 155 161 B1
/5/ DD 245 648 A1
/6/ DE 10 2006 046 803 A1
/7/ DE 101 09 892 B4
/8/ DE 10 2006 046 880 B4
/9/ DE 10 2006 032 452 B4
/10/ Chr. Bender: “Measurement and calculation of the resonance behaviour of coupled Helmholtz resonators in technical combustion systems”, Dissertation, University of Karlsruhe KIT, 2010

We claim:

1. A device for thermal treatment of a raw material in a oscillating hot gas flow of a pulsation reactor, with a burner, which produces oscillating hot gas flow, whereby the flame is arranged in a combustion chamber, the burner is fed via at least one pipeline, wherein a reaction space adjoins the combustion chamber, wherein the a pulsation device that can be externally driven for at least one part of the mass flow, which is guided to the burner, is arranged downstream of the pipeline leading to the flame.

2. The device as claimed in claim 1, wherein the combustion chamber is provided with at least one element for changing its geometry.

3. The device as claimed in claim 1, wherein the reaction chamber is provided with at least one element for modifying its geometry.

4. The device as claimed in claim 1, wherein the pulsation device is a cylinder/piston unit.

5. The device as claimed in claim 1, wherein the pulsation device is a diaphragm, which is arranged in the pipeline leading to the burner and which forms a wall and which can be externally excited to oscillations.

6. The device as claimed in claim 1, wherein the pulsation device has a cylindrical housing, on the circumferential surface of which at least one opening is located with at least one sinusoidal edge, through which the mass flow flows towards the flames and which can be closed and opened with control.

7. The device as claimed in claim 1, wherein the pulsation device is provided with a bypass mass-flow opening.

8. The device as claimed in claim 1, wherein the mass flow comprises a fuel gas/air mixture, which is fed to the burner for the flame.

9. A method of thermal treatment of a raw material in an oscillating hot gas flow of a pulsation reactor, comprising a burner, to which a mass flow of fuel gas and air is supplied, via at least one pipeline, to form at least one flame, which generates the hot gas flow, whereby the flame is disposed in a burner, to which a reaction chamber is connected, wherein the mass flow to the burner is provided with an externally determined frequency and amplitude with pulsation.

10. The method as claimed in claim 9, wherein the geometry of the combustion chamber and/or of the reaction chamber can be adjusted to change a resonance frequency.
